(19) United States
(12) Patent Application Publication
(10) Pub. No.: US 2016/0128338 A1
(43) Pub. Date: May 12, 2016

(54) COMPOSITION AND METHODS FOR IMPROVED TURF HEALTH

(71) Applicant: Valent U.S.A., Corporation, Walnut Creek, CA (US)

(72) Inventors: Todd James Mayhew, Gilbert, AZ (US); Jill Marie Calabro, Annapolis, MD (US)

(21) Appl. No.: 14/534,528

(22) Filed: Nov. 6, 2014

(51) Int. Cl. A01N 63/02; A01N 43/653

(52) U.S. Cl. CPC A01N 63/02; A01N 43/653

(57) ABSTRACT

The invention relates to compositions and methods for improving the health, appearance, and quality of turf grasses by application of compositions containing metconazole and Myrothecium verucaria fermentation solids and solubles to areas of turf grass growth.

### FIELD OF THE INVENTION

The present invention is directed to compositions that improve turf health containing metconazole and Myrothecium verucaria fermentation solids and solubles. The present invention is also directed to methods of improving turf health by reducing turf disease by application of compositions containing metconazole and Myrothecium verucaria fermentation solids and solubles to the turf grasses.

### BACKGROUND OF THE INVENTION

The present compositions contain the fungicide metconazole and the nematicide Myrothecium verucaria fermentation solids and solubles. The present methods are directed to applying effective amounts of metconazole and Myrothecium verucaria fermentation solids and solubles to an area in need of improved turf health. The present methods also improve turf quality, including coloration, density, and playability and reduce the presence of turf diseases.

Turf grass managers struggle to maintain turf grasses in excellent condition. Turf grasses must be aesthetically pleasing and healthy because they cover areas of lawn that generate high revenue such as golf courses. Numerous pests threaten the health and appearance of turf grasses. Such pests include weeds, insects and mites, diseases caused by fungi and bacteria, and nematodes. Turf grass managers often use chemicals to prevent damage to the grasses from these pests. Often, multiple applications are required for effective pest control, especially when environmental conditions are favorable for pests.

One fungicide that is effective against fungal infections in turf grasses is metconazole. Although metconazole is very effective, it cannot be used on cool season type turfs during times of high temperature stress. When the temperature is too high, the root systems degrade to compensate for reduced photosynthate production. If metconazole is applied during a period of heat stress, discoloration of the turf and growth regulation may occur. Therefore, turf managers must use other less effective fungicides during periods of warmer temperatures.

Myrothecium verucaria is known to control plant feeding nematodes but has not been shown to enhance turf quality (above what nematode protection would deliver). Further, Myrothecium verucaria is not known to have any fungicidal activity.

One of the biggest challenges for turf grass managers is the control of damage due to the fungus dollar spot. Some golf courses spend the majority of their budgets on treatments for the disease. Dollar spot plagues the majority of North America and some species have developed resistance to benzimidazoles, dicarboximides, and sterol biosynthesis inhibitors.

Creeping bentgrass is a turf grass commonly used in golf courses and other recreational lawn areas. Unfortunately, creeping bentgrass is very susceptible to dollar spot.

Therefore, there is a need in the art for a highly effective and safe turf grass fungicidal treatment. There is especially a need for an effective and potent dollar spot treatment on turf grass, especially on creeping bentgrass.

### SUMMARY OF THE INVENTION

Applicants have discovered that a combination of a DMI fungicide and a nematicide provide superior fungal disease resistance resulting in improved plant health, appearance and quality.

In one aspect, the invention is compositions for improving turf grass health comprising an effective amount of a DMI fungicide and an effective amount of a nematicide. Applicants' compositions are especially effective if they include metconazole as the DMI fungicide and Myrothecium verucaria fermentation solids and solubles as the nematicide. Applicants' found superior results using Myrothecium verucaria strain ATCC 0225.

In another aspect, Applicants' compositions can be applied to turf grasses if desired improvements in turf health, quality, appearance and disease resistance are desired.

In yet another aspect, DMI fungicides of the present invention can be applied without phytotoxicity to turf grasses in warmer temperatures than previously possible.

Applicants' compositions can be applied to areas growing a variety of turf grasses, such as creeping bentgrass. Applicants' methods are effective on many types of diseases, but especially effective against fungal infections such as dollar spot.

### DETAILED DESCRIPTION OF THE INVENTION

The present invention is directed to compositions and methods including a DMI fungicide, such as metconazole, and a nematicide, such as Myrothecium verucaria strain ATCC 0225 fermentation solids and solubles.

Metconazole (5-[(4-chlorophenyl)methyl]-2,2-dimetyl-1-(1 H-1,2,4-triazol-1-ylmethyl)cyclopentanol) is a sterol demethylation inhibitor (DMI) fungicide. Specifically, metconazole is an inhibitor of ergosterol biosynthesis and interferes with synthesis of fungal cell membranes.

Myrothecium verucaria is a fungal plant pathogen. If the fungus is fermented in liquid and then killed, however, the liquid contains solids and solubles containing metabolites that are nematicidal to parasitic nematodes. The metabolites used herein may be in the form of an entire culture medium (including mycelium) obtained by culturing a fungus of the species Myrothecium verucaria. Alternatively, the metabolite may be one or more particular fractions or components isolated from such a culture medium, extracted and purified according to procedures well-known in the art. It is also to be expected that such a component, upon elucidation of its structural formula, could be synthesized de novo using known chemical methods. “Metabolite” and “solids and solubles” as used herein mean any of the above; however, the metabolites and solids and solubles of the present invention are preferably a whole-culture preparation obtained by fermentation and heat-killing of Myrothecium verrucaria, and in particular of M. verrucaria strain ATCC 0225.

Applicants surprisingly discovered that applying a DMI fungicide with a nematicide resulted in superior turf health, quality, and fungal disease control when compared to a fungicide applied alone. These results were unexpected because one skilled in the art would not have expected a nematicide to improve turf unless nematode infestation is known or anticipated. Further, the combination was not expected to provide superior qualities to the turf when compared to known turf quality improvers.

Applicants found that the compositions and methods of the present invention are especially effective on creeping bentgrass. Creeping bentgrass (Agrostis stolonifera) is a cool season perennial grass. Creeping bentgrass is frequently used for golf course putting greens, lawn bowling greens, and lawn tennis facilities. This finely-textured bright green grass is low growing with a shallow root system which requires significant maintenance.

Applicants found that the composition and methods of the present invention are especially effective in controlling dollar spot. Dollar spot (Sclerotinia homoeocarpa) is a fungal pathogen that blights leaf tissues. Dollar spot is a major issue on turf grasses such as creeping bentgrass. Accordingly, dollar spot is a major concern of golf course turf managers.

Applicants were surprised that the compositions and methods of the present invention provided excellent dollar spot control in creeping bentgrass. It was not expected that a nematicide and fungicide mixture would provide increased control of a fungus when compared to the fungicide alone. Nematicides have no known impact on fungal growth. Including a nematicide treatment to a turf grass plot where plants are grown would not obviously improve the effectiveness of a fungicide. This is especially true when the nematicide and fungicide mixture is applied to turf grass plots without nematodes.

In one embodiment, the invention is directed to a composition for improving turf grass health comprising an effective amount of a DMI fungicide and an effective amount of a nematicide. In an embodiment, the DMI fungicide is metconazole. In a further embodiment, the nematicide is Myrothecium verucaria fermentation solids and solubles. In a preferred embodiment, the Myrothecium verucaria is strain ATCC 0225.

In another embodiment the effective amount of DMI fungicide is from about 0.05 oz/1000 ft² to about 0.35 oz/1000 ft², preferably from about 0.09 oz/1000 ft² to about 0.22 oz/1000 ft², and more preferably from about 0.15 oz/1000 ft² to about 0.20 oz/1000 ft² of the treated turf. For example, when metconazole is the DMI fungicide, the effective amount is from about 0.05 oz/1000 ft² to about 0.22 oz/1000 ft², preferably from about 0.13 oz/1000 ft² to about 0.22 oz/1000 ft², more preferably from about 0.15 oz/1000 ft² to about 0.20 oz/1000 ft², and most preferred at about 0.18 oz/1000 ft² of the treated turf.

In a further embodiment, the effective amount of the nematicide is from about 1 oz/1000 ft² to about 42 oz/1000 ft², preferably from about 1 oz/1000 ft² to about 7 oz/1000 ft², more preferably from about 2 oz/1000 ft² to about 5 oz/1000 ft² of the treated turf. For example, when Myrothecium verucaria fermentation solids and solubles is the nematicide, the effective amount is from about 1 oz/1000 ft² to about 42 oz/1000 ft², preferably from about 1 oz/1000 ft² to about 7 oz/1000 ft², more preferably from about 2 oz/1000 ft² to about 5 oz/1000 ft², and most preferred at about 2.7 oz/1000 ft² of the treated turf.

In a preferred embodiment, Myrothecium verucaria fermentation solids and solubles is derived from strain ATCC 0225.

In one embodiment, the composition of the present invention can be applied to turf grasses when the ratio of metconazole to Myrothecium verucaria strain ATCC 0225 fermentation solids and solubles is from about 0.01:1 to about 0.1:1 by weight. In a more preferred embodiment, the ratio is from about 0.04:1 to about 0.08:1 by weight, and most preferred at a ratio of about 0.06:1 by weight.

In further embodiments, the invention is directed to methods for improving turf grass growth. These methods include improving the resistance of turf grasses to fungal infections, improving the turf grass health, improving the turf grass quality, and improving the turf grass disease resistance.

The methods of the present invention are especially effective on turf grasses such as creeping bentgrass.

The methods of the present invention are especially effective against disease caused by dollar spot.

In another embodiment, the composition is applied to turf grasses and the effective amount of the DMI fungicide is from about 0.05 oz/1000 ft² to about 0.35 oz/1000 ft² and the effective amount of the nematicide is from about 1 oz/1000 ft² to about 42 oz/1000 ft². If metconazole is used in the present methods, then the effective amount is from about 0.05 oz/1000 ft² to about 0.22 oz/1000 ft². If Myrothecium verucaria strain ATCC 0225 is used in the present methods, then the effective amount is from about 1 oz/1000 ft² to about 42 oz/1000 ft².

In a further embodiment, the present invention is directed to methods for safening a DMI fungicide comprising application of a DMI fungicide with a nematicide. In a preferred embodiment, a nematicide is applied with metconazole to extend the period of time when metconazole can be safely applied to plants. This time frame is extended from a cooler season into a warmer season because less metconazole needs to be applied when the nematicide is concurrently applied.

In yet another embodiment, the nematicide is Myrothecium verucaria strain ATCC 0225 fermentation solids and solubles.

In a further embodiment, the invention is directed to safening metconazole treatments comprising applying from about 0.05 oz/1000 ft² to about 0.22 oz/1000 ft² of metconazole concurrently with from about 1 oz/1000 ft² to about 42 oz/1000 ft² of treated turf of the Myrothecium verucaria strain ATCC 0225 fermentation solids and solubles.

Other DMI fungicides that could be used in accordance with the invention include cyproconazole, difenconazole, fenarimol, myclobutanil, propiconazole, tebuconazole, triadimefon, and triticonazole.

Dollar spot can infect most grasses, including cool and warm season growers. These grasses include, but are not limited to, the following species: creeping bentgrass (Agrostis stolonifera), annual bluegrass (Poa annua), Kentucky bluegrass (Poa pratensis), perennial ryegrass (Lolium perenne), hybrid bermudagrasses (Cynodon dactylon x tranvaalensis), seashore paspalum (Paspalum vaginatum), zoysiagrass (Zoysia spp.), colonial bentgrass (Agrostis capillaris), annual ryegrass (Lolium multiflorum), bahiagrass (Paspalum notatum) buffalograss (Buchloe dactyloides), carpetgrass (Axonopus affinis), centipedegras (Eremochloa ophiuroides), fine fescue (Festuca spp.), kikuyugrass (Pennisetum clandestinum), orchardgrass (Dactylis glomerate), quackgrass (Elymus repens), rough bluegrass (Poa trivialis), St. Augustinegrass (Stenotaphrum secondatum), and tall fescue (Festuca arundinacea). Each of these grasses can be treated in accordance with the invention.

Other fungal diseases that could be controlled in accordance with the invention include anthracnose (Colletotrichum graminicola), brown patch (Rhizoctonia solani), gray leaf spot (Pyricularia grisea), necrotic ringspot (Ophiosphaerella korrae), red thread (Laetisaria fuciformis), large patch (Rhizoctonia solani), rust diseases (Puccinia spp.), summer patch (Magnaporthe poae), take all patch (Gaeumannomyces graminis), brown ring patch (Waitea circinate), zoysia patch (Rhizoctonia solani), fairy ring (various Basidiomycetes), Microdochium patch (Microdochium nivale), gray snow mold (Typhula spp.), and yellow patch (Rhizoctonia cerealis).

Applicants' mixtures can be applied in any convenient means. Those skilled in the art are familiar with the modes of application that include foliar applications such as spraying, chemigation (a process of applying the mixture through the irrigation system), by granular application, or by impregnating the mixture on fertilizer.

In one embodiment, the metconazole and Myrothecium verucaria fermentation solids and solubles can be applied together as a tank mix and applied simultaneously or as a premix to an area in need of turf quality improvement. In another embodiment, the metconazole and Myrothecium verucaria fermentation solids and solubles can be combined with other nutritional turf supplements, such as fertilizers and micronutrients.

The composition of the present invention may be formulated to contain adjuvants, such as solvents, anti-caking agents, stabilizers, defoamers, slip agents, humectants, dispersants, wetting agents, thickening agents, emulsifiers, and preservatives which increase the long lasting activity of the actives. Other components that enhance the biological activity of these ingredients may optionally be included.

Applicants' compositions can include one or more additional pesticides. Applicants' compositions can also include an herbicide. Further, the compositions can include additional ingredients to increase the effectiveness of the active ingredients.

As used herein, “turf grass” includes grasses grown in recreation lawns.

As used herein, “turf quality” means an improvement in turf color, turf density, turf playability, and/or turf texture.

As used herein, “turf health” means an improvement in turf disease resistance, turf vigor, and/or in overall appearance.

As used herein, “safening” means reducing the negative effects of a treatment. For example, compositions of the present invention allow for a DMI fungicide to be applied during times when the temperature would render DMI fungicide application to be harmful to turf grasses. When the DMI fungicide is applied with a nematicide at the same temperature, the DMI fungicide does not harm the turf grass.

As used herein, “oz” is an abbreviation for ounce, a unit of mass.

As used herein, all numerical values relating to amounts, weight percentages and the like are defined as “about” or “approximately” each particular value, namely, plus or minus 10%. For example, the phrase “at least 5% by weight” is to be understood as “at least 4.5% to 5.5% by weight.” Therefore, amounts within 10% of the claimed values are encompassed by the scope of the claims.

The term “effective amount” means the amount of the composition that will provide an improvement in turf grasses. The “effective amount” will vary depending on the formulation concentration, the type of plants(s) being treated, the severity of the pest infestation, the result desired, and the life stage of the pests during treatment, among other factors. Thus, it is not always possible to specify an exact “effective amount.” However, an appropriate “effective amount” in any individual case may be determined by one of ordinary skill in the art.

The mixture of the present invention can be applied to any environment in need of pest, or specifically fungal, control. The environment in need of pest control may include any area that is desired to have a reduced number of pests or to be free of pests. For example, the fungicide and nematicide combination can be applied to an area used to grow turf grasses, such as a lawn, golf course, or park.

The disclosed embodiments are simply exemplary embodiments of the inventive concepts disclosed herein and should not be considered as limiting, unless the claims expressly state otherwise.

The following examples are intended to illustrate the present invention and to teach one of ordinary skill in the art how to use the formulations of the invention. They are not intended to be limiting in any way.

To determine the effectiveness of the combination, the present invention was compared with a strobilurin fungicide alone, and in combination with metconazole. The strobilurin fungicide formulation contains 2-[2-(2,5-dimethylphenoxymethyl)phenyl]-2-methoxy-N-methylacetamide in a proprietary formulation (“Strobilurin”).

Tourney™ 50 WDG (available from Valent BioSciences Corporation) was used throughout the examples as the source of metconazole. Tourney™ 50 WDG includes 48.5 to 51.5% by weight metconazole and is a water dispersible granular formulation.

DiTera® DF (available from Valent BioSciences Corporation) was used throughout the examples as the source of Myrothecium verucaria fermentation solids and solubles. DiTera® DF includes 90% w/w of Myrothecium verucaria strain ATCC 0225 as a dry flowable.

### EXAMPLES

### Example 1

In order to determine the efficacy of combinations of metconazole and Myrothecium verucaria fermentation solids and solubles, numerous treatments were applied to plots in an area of turf grass. Specifically, the plots had established creeping bentgrass growing. No weed infestation was observed. Each plot was 30 square feet and the treatments were done in four replications. A randomized control was included in each block. The plots were no-till golf fairways. The treatments were applied during times of heat stress and also during times when no heat stress was present. The treatment solutions were prepared by pouring the liquid and dispersible granules in water and mixing. Treatments were applied to the turf grass at a volume of 2 gallons (256 liquid ounces)/1000 ft² with a CO₂ backpack sprayer at 34 psi with a ground speed of 1 mph. The plots received six applications on 22 May, 6 June, 19 June, 4 July, 17 July, and 14 August.

The turf grass was evaluated approximately every 7 days. Results from this experiment are provided below in the tables labeled “Table 1. Effect of Metconazole and Myrothecium verucaria fermentation solids and solubles on Dollar Spot on Creeping Bentgrass Fairways (% Damage)” and “Table 2. Effect of Metconazole and Myrothecium verucaria fermentation solids and solubles on Dollar Spot on Creeping Bentgrass Fairways (Quality Rating Based on a Scale of 1-9)”.

TABLE 1
Effect of Metconazole and Myrothecium verucaria on Dollar Spot on Creeping Bentgrass
Fairways (% Damage)

| | | Rate (oz | 6 | 15 | 22 | 26 | 3 | 10 | 17 | 25 | 31 | 7 | 14 | 21 |
|---|---|---|---|---|---|---|---|---|---|---|---|---|---|---|
| Plot | Treatment | ai/1000 sq ft.) | June | June | June | June | July | July | July | July | July | Aug | Aug | Aug |
| 1 | Untreated | NA | 19.5 | 28.8 | 32.5 | 43.8 | 62.5 | 45.0 | 48.8 | 26.8 | 55.0 | 58.8 | 55.0 | 40.0 |
| | Control | | | | | | | | | | | | | |
| 2 | Metconazole | 0.14 | 8.8 | 7.5 | 10.0 | 11.3 | 16.3 | 32.5 | 36.3 | 24.3 | 31.3 | 36.3 | 55.0 | 37.5 |
| 3 | Strobilurin | 0.15 | 5.3 | 5.0 | 8.8 | 3.5 | 9.3 | 10.0 | 12.5 | 9.8 | 17.5 | 22.5 | 58.8 | 45.0 |
| 4 | Strobilurin | 0.13 | 5.5 | 6.3 | 8.8 | 4.3 | 10.5 | 27.5 | 31.3 | 14.8 | 16.8 | 23.8 | 45.0 | 38.8 |
| 5 | Strobilurin + | 0.08 | 3.3 | 6.3 | 6.8 | 4.3 | 8.0 | 11.3 | 17.5 | 10.5 | 18.8 | 23.8 | 55.0 | 45.0 |
| | Metconazole | 0.09 | | | | | | | | | | | | |
| 6 | Strobilurin + | 0.13 | 4.5 | 3.3 | 4.0 | 2.8 | 8.0 | 4.5 | 6.8 | 2.8 | 16.3 | 21.3 | 53.8 | 46.3 |
| | Metconazole | 0.14 | | | | | | | | | | | | |
| 7 | Metconazole + | 0.18 | 2.0 | 0.8 | 1.0 | 1.0 | 0.8 | 7.3 | 11.3 | 8.0 | 7.5 | 15.0 | 36.3 | 46.3 |
| | M. verucaria | 2.7 | | | | | | | | | | | | |

TABLE 2
Effect of Metconazole and Myrothecium verucaria on Dollar Spot on Creeping
Bentgrass Fairways (Quality Rating Based on a Scale of 1-9)

| | | Rate (oz | 15 | 22 | 26 | 3 | 10 | 17 | 25 | 31 | 7 | 14 | 21 |
|---|---|---|---|---|---|---|---|---|---|---|---|---|---|
| Plot | Treatment | ai/1000 sq ft.) | June | June | June | July | July | July | July | July | Aug | Aug | Aug |
| 1 | Untreated | NA | 3.3 | 3.3 | 2.8 | 3.0 | 3.5 | 3.3 | 4.3 | 4.0 | 3.5 | 3.5 | 4.0 |
| | Control | | | | | | | | | | | | |
| 2 | Metconazole | 0.14 | 6.0 | 5.5 | 5.5 | 4.5 | 3.8 | 3.5 | 4.8 | 4.8 | 4.8 | 4.0 | 4.3 |
| 3 | Strobilurin | 0.15 | 6.0 | 5.5 | 6.0 | 5.3 | 5.0 | 4.8 | 5.3 | 5.0 | 4.8 | 3.3 | 4.0 |
| 4 | Strobilurin | 0.13 | 5.8 | 5.3 | 5.3 | 5.0 | 4.5 | 4.3 | 4.8 | 5.0 | 5.3 | 3.5 | 4.3 |
| 5 | Strobilurin + | 0.08 | 5.8 | 5.8 | 6.0 | 5.3 | 4.8 | 4.5 | 5.3 | 5.0 | 5.0 | 3.5 | 4.0 |
| | Metconazole | 0.09 | | | | | | | | | | | |
| 6 | Strobilurin + | 0.13 | 6.3 | 5.8 | 5.8 | 5.3 | 5.8 | 5.3 | 5.8 | 5.3 | 5.0 | 3.8 | 4.0 |
| | Metconazole | 0.14 | | | | | | | | | | | |
| 7 | Metconazole + | 0.18 | 6.8 | 6.5 | 6.5 | 6.0 | 5.5 | 4.8 | 5.3 | 5.5 | 5.0 | 4.0 | 4.0 |
| | M. verucaria | 2.7 | | | | | | | | | | | |

Applicants surprisingly discovered that applying a combination of metconazole and Myrothecium verucaria fermentation solids and solubles to turf grasses improved turf grass health. This combination controlled dollar spot better than other known fungicides. Applicants were surprised by these results because there was no known nematode activity in the fields. There was also no known weed infestation. It was unexpected to those of skill in the art that Myrothecium verucaria fermentation solids and soluble provided improved turf grass appearance and that it increased the performance of the fungicide metconazole.

1. A composition for improving turf grass health comprising an effective amount of a sterol demethylation inhibitor (DMI) fungicide and an effective amount of a nematicide.

2. The composition of claim 1 wherein the DMI fungicide is metconazole.

3. The composition of claim 2 wherein the nematicide is Myrothecium verucaria fermentation solids and solubles.

4. The composition of claim 1 wherein the nematicide is Myrothecium verucaria strain ATCC 0225.

5. The composition of claim 2 wherein the effective amount of metconazole is from about 0.05 oz per 1,000 square feet to about 0.22 oz per 1000 square feet of turf.

6. The composition of claim 3 wherein the effective amount of Myrothecium verucaria fermentation solids and solubles is from about 1 oz per 1000 square feet to about 42 oz per 1000 square feet of turf.

7. The composition of claim 3 wherein the ratio of metconazole to Myrothecium verucaria fermentation solids and solubles is from about 0.01:1 to about 0.1:1 by weight.

8. The composition of claim 6 wherein the effective amount of metconazole is from about 0.09 oz per 1,000 square feet to about 0.22 oz per 1000 square feet and the effective amount of Myrothecium verucaria fermentation solids and solubles is from about 1 oz per 1000 square feet to about 7 oz per 1000 square feet of turf.

9. The composition of claim 6 wherein the effective amount of metconazole is about 0.18 oz per 1,000 square feet the effective amount of Myrothecium verucaria fermentation solids and solubles is about 2.7 oz per 1000 square feet of turf.

10. A method of improving resistance of turf grasses to fungal infection comprising applying the composition of claim 3 to turf grass.

11. The method of claim 10 wherein the turf grass is creeping bentgrass.

12. The method of claim 10 wherein the fungal infection is caused by dollar spot.

13. A method of improving turf grass health comprising applying the composition of claim 3 to turf grass.

14. The method of claim 13 wherein the effective amount of metconazole is from about 0.09 oz per 1000 square feet to about 0.22 oz per 1000 square feet and the effective amount of Myrothecium verucaria fermentation solids and solubles is from about 1 oz per 1000 square feet to about 7 oz per 1000 square feet of turf.

15. The method of claim 13 wherein the effective amount of metconazole is about 0.18 oz per 1,000 square feet the effective amount of Myrothecium verucaria fermentation solids and solubles is about 2.7 oz per 1000 square feet of turf.

16. A method of improving turf grass quality comprising applying the composition of claim 3 to turf grass.

17. A method of improving turf grass disease resistance comprising applying the composition of claim 3 to turf grass.

18. A method for safening a DMI fungicide comprising application of a DMI fungicide with a nematicide.

19. The method of claim 18 wherein the DMI fungicide is metconazole.

20. The method of claim 19 wherein the nematicide is Myrothecium verucaria strain ATCC 0225.
